(19) United States
(12) Patent Application Publication
(10) Pub. No.: US 2019/0051146 A1
(43) Pub. Date: Feb. 14, 2019

(54) THREE-DIMENSIONAL MULTI-POINT MULTI-INDEX EARLY WARNING METHOD FOR RISK AT POWER GRID TOWER IN LANDSLIDE SECTION

(71) Applicant: Institute of Mountain Hazards and Environment, Chinese Academy of Sciences, Chengdu (CN)

(72) Inventors: Yuanjun JIANG, Chengdu (CN); Siyou XIAO, Xiangtan (CN); Yue SONG, Chengde (CN); Zhen JIANG, Chengdu (CN); Meng WANG, Chengdu (CN)

(73) Assignee: Institute of Mountain Hazards and Environment, Chinese Academy of Sciences, Chengdu (CN)

(21) Appl. No.: 15/695,016

(22) Filed: Sep. 5, 2017

(30) Foreign Application Priority Data
Aug. 9, 2017 (CN) 201710674005.6

(51) Int. Cl. G08B 31/00; G06Q 50/06; G08B 21/10

(52) U.S. Cl. CPC G08B 31/00; G06F 17/16; G08B 21/10; G06Q 50/06

(57) ABSTRACT

A three-dimensional multi-point and multi-index early warning method for risk at a power grid tower in a landslide section, including: (1) classifying the risk level of each index; (2) obtaining the value of various indexes of the power grid tower in a landslide section during a certain period of time. (3) calculating the single-index measure of each index, and obtaining the evaluating matrix of the single index measure; (4) determining the weight of each index; (5) calculating the multi-index comprehensive measure of the landslide and power tower; (6) introducing the confidence level λ to determine the comprehensive risk level of the power tower instability; (7) performing early warning based on risk level. The invention greatly improves the warning accuracy of the landslide, and realizes the accurate judgment and warning of danger of the tower.

### CROSS REFERENCE TO RELATED APPLICATIONS

This application is based upon and claims priority to Chinese Patent Application No. 201710674005.6, filed on Aug. 9, 2017, the entire contents of which are incorporated herein by reference.

### TECHNICAL FILED

The present invention relates to a three-dimensional multi-point multi-index early warning method for the risk at the power grid tower in a landslide section.

### BACKGROUND

Currently, the key to the early warning technology for rainfall-type landslide lies in the establishment of the relationship between the occurrence of landslide and the critical value of rainfall. There are lots of methods that have been used by scholars to determine the critical value of rainfall-induced landslide. Three main methods involve: (1) the critical value of rainfall intensity, (2) the critical value of rainfall capacity, and (3) the critical value of water content of soil.

In above three methods, the advantage of the first method is that it is easy to implement, but it ignores the situation of early stage and the water content of soil, so the method cannot represent the local geological conditions, and the analysis for cause is not rigorous. Therefore, the scientific forecast of some of the geological disasters cannot be determined. The second method takes the situation of early stage and water content into account, so the obtained relative critical value is more accurate, but it needs more resources and data and does not take environmental factors, such as terrain, etc., into account. For the third method, the biggest problem is that it cannot determine the landslide type, landslide activity characteristics, and landslide scale. Therefore, for the landslide warning model established based on the above three methods, the accuracy of landslide warning is low. When determining whether the power project has the long-term stability, it is required to conduct a comprehensive analysis of the geological environment, hydrogeological environment where the project is located for a long time, and the power tower structure, so as to obtain more accurate conclusions. Therefore, under certain conditions where the landslide warning's accuracy is low, there will be a big error in determining and generating early warning of the risk level of the power grid tower in the existing technology.

### SUMMARY OF THE INVENTION

The objective of the present invention is to provide a three-dimensional multi-point and multi-index early warning method for risk at a power grid tower in a landslide section, for solving the problem of low accuracy of the existing landslide warning methods.

In order to achieve the above objective, the technical solution adopted by the present invention is as follows.

A three-dimensional multi-point and multi-index early warning method for risk at a power grid tower in a landslide section comprises the following steps:

(1) establishing a three-dimensional numerical model of landslide slope, and then performing single-index risk classification on each of six indexes, including rainfall intensity, rainfall pattern, cumulative rainfall capacity, saturability of slope rock-soil body, slope of lower retaining wall, slope of tower base by using a finite difference method to classify each index into four levels from high to low: I, II, III and IV in terms of risk; at the same time, performing single-index classification on crack width and slope of tower based on Technique Code for Building Slope Engineering and Technical Code for Design of tower and pole structures of overhead transmission line to classify each of the crack width and the slope of tower into four levels from high to low: I, II, III, IV in terms of risk;

(2) obtaining the value of each of the indexes, including the rainfall intensity a, rainfall pattern b, the cumulative rainfall capacity c, the saturability of slope rock-soil body d, in a landslide section during a certain period of time, wherein the unit of rainfall intensity is mm/h; the rainfall pattern is divided into a gradually increasing type, a continuously stable type, a first-increasing-then-decreasing type, a gradually decreasing type; the value of the gradually increasing type is recorded as 1, the value of the continuously stable type is recorded as 2, the value of the first-increasing-then-decreasing type is recorded as 3, the value of the gradually decreasing type is recorded as 4; the unit of the cumulative rainfall capacity is mm; the saturability of slope rock-soil body is set to be 0-1 according to the water content of soil;

(3) obtaining the value of each of the indexes, including the crack width ‘a’, the slope of tower the slope of lower retaining wall ‘c’, the slope of tower base downslope ‘d’, of a power tower in the landslide section during the same period of time; wherein the unit of the crack width is mm, the unit of the slope of tower is ‰, the units of the slope of lower retaining wall and the slope of tower base downslope are °;

(4) obtaining a rainfall single-index measure evaluating matrix according to the value of each index obtained in step (2):

$$( {μ}_{ijk} ) = [ \begin{matrix}{C}_{a 1} & {C}_{a 2} & {C}_{a 3} & {C}_{a 4} \\ {C}_{b 1} & {C}_{b 2} & {C}_{b 3} & {C}_{b 4} \\ {C}_{c 1} & {C}_{c 2} & {C}_{c 3} & {C}_{c 4} \\ {C}_{d 1} & {C}_{d 2} & {C}_{d 3} & {C}_{d 4}\end{matrix} ]$$

wherein, Cₐ₁, Cₐ₂, Cₐ₃, Cₐ₄ are degrees that actually measured data of the rainfall intensity belong to the four levels of I, II, III, IV, respectively, and Cₐ₁+Cₐ₂+Cₐ₃+Cₐ₄=1; C_{b1}, C_{b2}, C_{b3}, C_{b4} are degrees that actually measured data of the rainfall pattern belong to the four levels of I, II, III, IV respectively, and C_{b1}+C_{b2}+C_{b3}+C_{b4}=1; C_{c1}, C_{c2}, C_{c3}, C_{c4} are degrees that actually measured data of the cumulative rainfall capacity belong to the four levels of I, II, III, IV, respectively, and C_{c1}+C_{c2}+C_{c3}+C_{c4}=1; C_{d1}, C_{d2}, C_{d3}, C_{d4} are degrees that actually measured data of the saturation of slope rock-soil body belong to the four levels of I, II, III, IV, respectively, and C_{d1}+C_{d2}+C_{d3}+C_{d4}=1;

(5) obtaining a slope-tower displacement single-index measure evaluating matrix according to the value of each index obtained in step (3):

$${( {μ}_{ijk} )}^{′} = [ \begin{matrix}{C}_{{a }^{′} 1} & {C}_{{a}^{′} 2} & {C}_{{a}^{′} 3} & {C}_{{a}^{′} 4} \\ {C}_{{b}^{′} 1} & {C}_{{b}^{′} 2} & {C}_{{b}^{′} 3} & {C}_{{b}^{′} 4} \\ {C}_{{c}^{′} 1} & {C}_{{c}^{′} 2} & {C}_{{c}^{′} 3} & {C}_{{c}^{′} 4} \\ {C}_{{d}^{′} 1} & {C}_{{d}^{′} 2} & {C}_{{d}^{′} 3} & {C}_{{d}^{′} 4}\end{matrix} ]$$

wherein, C_{a′1}, C_{a′2}, C_{a′3}, C_{a′4} are degrees that actually measured data of the crack width belong to the four levels of I, II, III, IV, respectively, and C_{a′1}+C_{a′2}+C_{a′3}+C_{a′4}=1; C_{b′1}, C_{b′2}, C_{b′3}, C_{b′4} are degrees that actually measured data of the slope of the tower belong to the four levels of I, II, III, IV, respectively, and C_{b′1}+C_{b′2}+C_{b′3}+C_{b′4}=1; C_{c′1}, C_{c′2}, C_{c′3}, C_{c′4} are degrees that actually measured data of the slope of lower retaining wall belong to the four levels of I, II, III, IV, respectively, and C_{c′1}+C_{c′2}+C_{c′3}+C_{c′4}=1; C_{d′1}, C_{d′2}, C_{d′3}, C_{d′4} are degrees that actually measured data of the slope of tower base downslope belong to the four levels of I, II, III, IV, respectively, and C_{d′1}+C_{d′2}+C_{d′3}+C_{d′4}=1;

(6) determining the weights of the indexes, including the rainfall intensity, the rainfall pattern, the cumulative rainfall capacity, and the saturability of slope rock-soil body, as w₁, w₂, w₃, w₄, respectively, by an entropy weight method according to the single-index measure evaluating matrix obtained in steps (4) and (5); at the same time, determining the weights of the indexes, including the crack width, the slope of the power tower, the slope of the lower retaining wall, and the slope and the tower base downslope, as w′₁, w′₂, w′₃, w′₄, respectively;

(7) calculating multi-index comprehensive measures {A, B, C, D}, {A′, B′, C′, D′} of the slope and the power tower, respectively, according to the determined weight of the indexes, based on the following formula:

uⱼ=wⱼμⱼᵢₖ

(8) introducing a confidence degree λ=0.5, and comparing the confidence degree with the multi-index comprehensive measures {A, B, C, D}, {A′, B′, C′, D′}, respectively, to determine a comprehensive risk level of power tower instability; wherein the method for determining the comprehensive risk level of power tower instability comprises the following steps: using the left-to-right addition and comparison method, if A≥0.5 or A′≥0.5, then determining the comprehensive risk level of the power tower instability as level I; if A+B≥0.5 or A′+B′≥0.5, determining the comprehensive risk level of the power tower instability as level II; if A′+B′+C′≥0.5, determining the comprehensive risk level of the power tower instability as level III; if A+B+C+D>0.5 or A′+B′+C′+D′≥0.5, then determining the comprehensive risk level of the power tower instability as level IV;

(9) performing the corresponding early warning based on the comprehensive risk level of the power tower instability, and selecting the higher one among an early warning level of the rainfall index and the early warning level of the slope-tower displacement monitoring as a final early warning risk level.

Further, the rainfall intensity and the rainfall pattern is obtained by processing data of the rainfall intensity and the rainfall pattern measured by a rain gauge.

Furthermore, the cumulative rainfall capacity is determined by the formula as below:

Pₐ₀=KP₁+K²P₂+K³P₃+ . . . +KⁿPₙ

wherein: Pₙ(n=1, 2, 3 . . . n) refers to daily rainfall capacity n days before the outbreak of debris flow, n≥30; K is 0.8˜0.9.

Furthermore, the crack width is measured by a crack meter.

Furthermore, the slope of tower, the slope of lower retaining wall, and the slope of tower base downslope are all measured by a clinometer.

Compared with the prior art, the invention has the following advantages.

(1) Based on the further research on the landslide topography and the tower stability, the present invention determines suitable monitoring objects (rainfall intensity, rainfall pattern, cumulative rainfall capacity, saturability of slope rock-soil body, crack width, slope of tower, slope of lower retaining wall, slope of tower base downslope). Then the evaluating matrix is established respectively in combination with the information entropy and the unascertained degree method by setting the comprehensive risk level of the power tower instability and obtaining the indexes of rainfall intensity, rainfall pattern, cumulative rainfall capacity, saturability of slope rock-soil body in a landslide section during a certain period of time and the indexes of crack width, slope of tower, slope of lower retaining wall, slope of tower base downslope of a power grid tower during the same period of time, and then the single-index measure and the multi-index comprehensive measure are obtained. After that, the confidence degree recognition mechanism is introduced to finally achieve the determination of the comprehensive risk level of the power tower instability. The invention adopts the method of three-dimensional multi-point and multi-index to determine the comprehensive risk level of the power tower instability, and the process steps adopted are linked together and closely connected, so that the warning accuracy of the landslide is greatly improved and the accurate judgment and targeted early warning of the risk level of the power tower is realized.

(2) In determining the comprehensive risk level of the power tower instability, an early warning result with more dangerous level is selected as the final comprehensive risk level of the power tower instability in the present invention. That is to say, among the multi-index comprehensive measures {A, B, C, D} and {A B′, C D′}, the left-to-right addition and comparison method is used. If A or A′ is larger than or equal to the confidence degree λ (the value is 0.5), then it can be directly determined that the comprehensive risk level of the power tower instability is level I; if A+B or A′+B′ is larger than or equal to the confidence degree λ, then it can be directly determined that the comprehensive risk level of the power tower instability is level II; the rest are determined accordingly. For this way of risk level determination, the analysis on the stability of the slope where the power tower located under the rainfall infiltration is firstly conducted to give the stability of the slope under different rainfall intensity and rainfall conditions. The evaluation and analysis are performed to the given stability of the slope. After that, the monitoring and analysis are performed on the stability of the power tower infrastructure based on the above evaluation and analysis on stability of the slope to obtain the risk of the power tower collapse. Therefore, the way of determining the comprehensive risk level of the power tower instability in the present invention is very reasonable and effective.

(3) The way to obtain the monitoring object data by the present invention is simple, reasonable and accurate, and provides important guarantee for further determining the comprehensive risk level of the power tower instability.

### DETAILED DESCRIPTION OF THE EMBODIMENTS

The present invention will be further described in accompany with embodiments, including but not limited to the following embodiments.

The present invention provides a three-dimensional multi-point and multi-index early warning method for risk at a power grid tower in a landslide section, so as to realize the classification of the risk level and carry out the corresponding warning. The operation process of the present invention is described below.

In the present invention, the rainfall intensity, the rainfall pattern, the cumulative rainfall capacity, the saturability of slope rock-soil body, the slope of tower, the slope of lower retaining wall, and the slope of tower base downslope are selected, monitored, and regarded as the main indexes of the comprehensive risk level of the power tower instability. Firstly, the three-dimensional numerical model of landslide slope can be established (FLAC3D software can be used to establish the model), and then a single-index risk classification is performed on each of the six indexes, the rainfall intensity, the rainfall pattern, the cumulative rainfall capacity, the saturability of slope rock-soil body, the slope of lower retaining wall, the slope of tower base downslope by using a finite difference method. Each of these indexes are divided into four levels: I, II, III and IV according to the risk level from high to low. Then, a single-index classification is performed on the crack width and the slope of tower based on “Technical Code for Building Slope Engineering” (GB 50330-2013) and “Technical Code for The Design of Tower and Pole Structures of Overhead Transmission Line”. Then these indexes are divided into four levels: I, II, III, IV according to the risk level from high to low.

After dividing the risk level, the landslide is selected, and the value of each of the indexes, i.e., rainfall intensity a (unit: mm/h), rainfall pattern b, cumulative rainfall capacity c (unit: mm), saturability of slope rock-soil body d (the value is 0-1, according to the water content of soil) during a certain period of time, and the value of each of the indexes, i.e., the crack width a′ (unit: mm), the slope of power tower b′ (unit: ‰), the slope of lower retaining wall c′ (unit: °), and the slope of tower base d′ (unit: °) in a landslide section during the same period of time are obtained.

The rainfall pattern is divided into gradually increasing type, continuously stable type, first-increasing-then-decreasing type, gradually decreasing type (See ZHANG Sherong, TAN Yaosheng, WANG Chao, et al., influence of heavy rainfall characteristics on saturated-unsaturated slope failure, Chinese Journal of Rock Mechanics and Engineering, 2014). In the present invention, the value of the gradually increasing type is recorded as 1, the value of the continuously stable type is recorded as 2, the value of the first-increasing-then-decreasing type is recorded as 3, the value of the gradually decreasing type is recorded as 4. The rainfall intensity and the rainfall pattern are obtained by processing data of the rainfall intensity and the rainfall pattern measured by a rain gauge. In the present invention, since the rainfall intensity, the rainfall pattern in combination with the rainfall duration represent the total amount of rainfall, by taking the influence of various factors such as the spatial and temporal change, the radiation intensity, the evaporation amount and the soil permeability etc., into account, the cumulative rainfall capacity can be obtained from the following formula:

Pₐ₀=KP₁+K²P₂+K³P₃+ . . . +KⁿPₙ

wherein: Pₙ(n=1, 2, 3 . . . n) refers to the daily rainfall n days before the outbreak of debris flow, n≥30; K is 0.8˜0.9. In the present invention, K is a decreasing coefficient, and the appropriate value of K can be determined according to the weather conditions such as sunny days, cloudy days, and overcast days. For example, the value of K is selected as 0.9 in sunny days, the value of K is selected as 0.85 in cloudy days, and the value of K is selected as 0.8 in rainy and overcast days.

The crack width is measured by a crack meter. The slope of tower, the slope of lower retaining wall, and the slope of tower base downslope are all measured by the clinometer. During the slope monitoring process of the present invention, according to the simulation result and the safety factor, the safety factor without any discount is 1.36, and the slope of the lower part of tower base is 0.05°, i.e., when the slope of the lower part of the tower base is less than 0.06°, the influence level of the slope index of the slope of the lower part of the tower base is level IV. Similarly, when the slope of lower retaining wall is less than 0.05°, the influence level of the slope index of the lower part of the tower base is level IV. When the discount factor is 1.36/1.2, the corresponding safety factor is 1.2, the slope of the lower part or the tower base is 0.2°, the slope of the retaining wall is 0.13°, and the influence level is level III. When the discount factor is 1.36/1.05, the slope of the lower part of the tower base is 0.65°, the slope of the retaining wall is 0.51°, and the level is level II. When the slope of the lower part of the tower base is larger than 0.65°, the slope of the retaining wall is larger than 0.51°, and the level is level I.

After the numerical value of each index is obtained, two single-index measure evaluating matrixes can be obtained.

The first evaluating matrix (the rainfall single-index measure evaluating matrix) is as below:

$$( {μ}_{ijk} ) = [ \begin{matrix}{C}_{a 1} & {C}_{a 2} & {C}_{a 3} & {C}_{a 4} \\ {C}_{b 1} & {C}_{b 2} & {C}_{b 3} & {C}_{b 4} \\ {C}_{c 1} & {C}_{c 2} & {C}_{c 3} & {C}_{c 4} \\ {C}_{d 1} & {C}_{d 2} & {C}_{d 3} & {C}_{d 4}\end{matrix} ]$$

wherein, Cₐ₁, Cₐ₂, Cₐ₃, Cₐ₄ are degrees that actually measured data of the rainfall intensity belong to the four levels of I, II, III, IV, respectively, and Cₐ₁+Cₐ₂+Cₐ₃+Cₐ₄=1; C_{b1}, C_{b2}, C_{b3}, C_{b4} are degrees that actually measured data of the rainfall pattern belong to the four levels of I, II, III, IV respectively, and C_{b1}+C_{b2}+C_{b3}+C_{b4}=1; C_{c1}, C_{c2}, C_{c3}, C_{c4} are degrees that actually measured data of the cumulative rainfall capacity belong to the four levels of I, II, III, IV, respectively, and C_{c1}+C_{c2}+C_{c3}+C_{c4}=1; C_{d1}, C_{d2}, C_{d3}, C_{d4} are degrees that actually measured data of the saturation of slope rock-soil body belong to the four levels of I, II, III, IV, respectively, and C_{d1}+C_{d2}+C_{d3}+C_{d4}=1.

In the embodiment, the situation that the actually measured data of the rainfall intensity, the rainfall pattern, the cumulative rainfall capacity, and the saturability of slope rock-soil body belong to the four levels I, II, III, IV are shown in the following table:

| | rainfall | | cumulative | saturability of |
|---|---|---|---|---|
| | intensity/ | rainfall | rainfall capcaity | slope rock-soil |
| levels | (mm/h) | pattern | (mm) | body |
| Level I | ≥6 | 1 | ≥120 | ≥0.8 |
| Level II | 3~6 | 2 | 72~120 | 0.4~0.8 |
| Level III | 1~3 | 3 | 36~72 | 0.1~0.4 |
| Level IV | ≤1 | 4 | ≤36 | ≤0.1 |

The second evaluating matrix (the slope-tower displacement single-index evaluating matrix) is as below:

$${( {μ}_{ijk} )}^{′} = [ \begin{matrix}{C}_{{a }^{′} 1} & {C}_{{a}^{′} 2} & {C}_{{a}^{′} 3} & {C}_{{a}^{′} 4} \\ {C}_{{b}^{′} 1} & {C}_{{b}^{′} 2} & {C}_{{b}^{′} 3} & {C}_{{b}^{′} 4} \\ {C}_{{c}^{′} 1} & {C}_{{c}^{′} 2} & {C}_{{c}^{′} 3} & {C}_{{c}^{′} 4} \\ {C}_{{d}^{′} 1} & {C}_{{d}^{′} 2} & {C}_{{d}^{′} 3} & {C}_{{d}^{′} 4}\end{matrix} ]$$

Like the first evaluating matrix, in the second matrix, C_{a′1}, C_{a′2}, C_{a′3}, C_{a′4} are degrees that actually measured data of the crack width belong to the four levels of I, II, III, IV, respectively, and C_{a′1}+C_{a′2}+C_{a′3}+C_{a′4}=1; C_{b′1}, C_{b′2}, C_{b′3}, C_{b′4} are degrees that actually measured data of the slope of the tower belong to the four levels of I, II, III, IV, respectively, and C_{b′1}+C_{b′2}+C_{b′3}+C_{b′4}=1; C_{c′1}, C_{c′2}, C_{c′3}, C_{c′4} are degrees that actually measured data of the slope of lower retaining wall belong to the four levels of I, II, III, IV, respectively, and C_{c′1}+C_{c′2}+C_{c′3}+C_{c′4}=1; C_{d′1}, C_{d′2}, C_{d′3}, C_{d′4} are degrees that actually measured data of the slope of tower base downslope belong to the four levels of I, II, III, IV, respectively, and C_{d′1}+C_{d′2}+C_{d′3}+C_{d′4}=1.

In the embodiment, the situation that the actually measured data of the crack width, the slope of power tower, the slope of lower retaining wall, the slope of tower base downslope belongs to the four levels of I, II, III and IV are shown in the following table:

| | crack | slope of | slope of | slope of |
|---|---|---|---|---|
| | width | power | lower retaining | tower base |
| levels | (mm) | tower/‰ | wall/° | downslope/° |
| Level I | ≥20 | 20 | ≥0.65 | ≥0.51 |
| Level II | 10~20 | 15~20 | 0.2~0.65 | 0.13~0.51 |
| Level III | 1~10 | 10~15 | 0.06~0.2 | 0.05~0.13 |
| Level IV | ≤1 | ≤10 | ≤0.06 | ≤0.05 |

The origin of the above-mentioned single index measure evaluating matrix is as below.

Assuming that there are n evaluation objects R (i.e., landslide and power tower), the space of the evaluation object is R={R₁, R₂, . . . , Rₙ}. Providing that there are m single evaluation index space for each evaluation object Rᵢ (i=1, 2, . . . , n), i.e., X={X₁, X₂, . . . , Xₘ} then Rᵢ can be expressed as a m-dimensional vector Rᵢ={xᵢ₁, xᵢ₂, . . . , xᵢₘ}, wherein, xᵢⱼ represents the measured value of the evaluation object R, with respect to the evaluation index Xⱼ. For each sub-item xᵢⱼ (i=1, 2, . . . , n; j=1, 2, . . . , m), providing that there are p evaluation levels {C₁, C₂, . . . , Cₚ}.

The evaluation space is recorded as U, then U={C₁, C₂, . . . Cₚ}. Providing that Cₖ (k=1, 2, . . . , p) is the k-th level in the evaluation, and the risky degree of the kₜₕ level is higher than that of the (k+1)ₜₕ level, denoted as Cₖ>Cₖ₊₁. If C₁>C₂> . . . >Cₖ, then {C₁, C₂, . . . , Cₚ} is an ordered partition class of the evaluation space U.

Single-Index Measure

If μᵢⱼₖk=μ(xᵢⱼ∈Cₖ) represents the degree that the measured value xᵢⱼ belongs to the kₜₕ evaluation level Cₖ and is required to satisfy:

0≤μ(xᵢⱼ∈Cₖ)≤1 (1)

μ(xᵢⱼ∈U)=1 (2)

$$μ [ {x}_{ij} ∈ {{⋃}^{k}}_{l = 1} {C}_{l} ] = {{\sum }_{l = 1}}^{k} μ ( {x}_{ij} ∈ {C}_{l} ) ( k = 1 , 2 , … , p ) \qquad ( 3 )$$

wherein, formula (2) means that μ satisfies “normalization” to the evaluation space U; formula (3) means that μ satisfies “additivity” to the evaluation space U. The uncertainty measure of μ that satisfies formula (1), (2) and (3) is called measure for short.

Then, the matrix (μᵢⱼₖ)_{m×p} is the single index measure evaluating matrix, wherein the formula is shown as below:

$${( {μ}_{ijk} )}_{m \times p} = [ \begin{matrix}{C}_{i 1 \; 1} & {C}_{i 12} & … & {C}_{i 1 p} \\ {C}_{i 21} & {C}_{i 22} & … & {C}_{i 2 p} \\ ⋮ & ⋮ & ⋱ & ⋮ \\ {C}_{i m 1} & {C}_{i m 2} & … & {C}_{imp}\end{matrix} ]$$

After the single index measure evaluating matrix is obtained, the weights of indexes of rainfall intensity, rainfall pattern, cumulative rainfall capacity and saturability of slope rock-soil body are determined as w₁, w₂, w₃, w₄, respectively. The weights of indexes of crack width, slope of the power tower, slope of the lower retaining wall, and slope of tower base downslope are determined as w′₁, w′₂, w′₃, w′₄, respectively. The principle of such determination is as follows.

Assuming that wⱼ represents the importance of the measure index Xⱼ relative to other indexes, wⱼ needs to satisfy: 0≤wⱼ≤1 and

$${\sum }_{j = 1}^{m} {w}_{j} = 1 ,$$

then wⱼ is called the weight of Xⱼ, w={w₁, w₂, . . . , wₘ} is called the index weight vector. The weight is determined using entropy, i.e.:

$$\begin{matrix}{v}_{j} = 1 + \frac{1}{lg p} {\sum }_{i = 1}^{p} {μ}_{ji} lg {μ}_{ji} & ( 4 ) \\ {w}_{j} = {v}_{j} / {\sum }_{i = 1}^{n} {v}_{i} & ( 5 )\end{matrix}$$

Since the single index measure evaluating matrix is known, wⱼ can be obtained by formulas (4) and (5).

Then, according to the determined index weight, the respective multi-index comprehensive measures {A, B, C, D}, {A′, B′, C′, D′} of the landslide and the power grid tower are calculated based on the following formula:

uⱼ=wⱼμⱼᵢₖ;

The formula and the calculated multi-index comprehensive measures come from the following:

$${μ}_{ik} = {\sum }_{j = 1}^{m} {w}_{ij} {μ}_{ijk} \\ ( I = 1 , 2 , … , n ; j = 1 , 2 , … , m ; k = 1 , 2 , … , p )$$

Wherein: 0≤μₖ≤1, in

$${\sum }_{k = 1}^{p} {μ}_{ik} = 1 ,$$

μₜₖ is called the unascertained measure, {μₜ₁, μₜ₂, . . . , μₜₚ} is the evaluation vector of the multi-index comprehensive measure for xᵢ.

After that, in order to make the final evaluation result for the evaluation object, the confidence degree λ with a value of 0.5 is introduced in the present invention and compared with the multi-indexes comprehensive measures {A, B, C, D}, {A′, B′, C′, D′}, respectively to determine the comprehensive risk level of the power tower instability. The determination method is as follows: the left-to-right addition and comparison method is used, if A≥0.5 or A′≤0.5, then the comprehensive risk level of the power tower instability is determined as level I; if A+B≥0.5 or A′+B′≥0.5, the comprehensive risk level of the power tower instability is determined as level II; if A′+B′+C′≥0.5, the comprehensive risk level of the power tower instability is determined as level III; if A+B+C+D≥0.5 or A′+B′+C′+D′≥0.5, then the comprehensive risk level of the power tower instability is determined as level IV. Finally, the corresponding monitoring system is arranged based on the comprehensive risk level of the power tower instability, and the monitoring and warning are performed.

The monitored data of 500 kV two-in-one line #313 and #314 tower rainfall station (serial number hftk41aq) in November 2016 is given as an example, to determine the comprehensive risk level of the power tower instability.

Due to the abundant sunshine in Zhaojue County, there is no obvious rainfall in the early stage. Thus, the general water content of the soil is considered as the saturation of the slope rock-soil body, the value of which is 0.1. And then, the evaluation indexes for the heavy rainfall in November are determined according to the monitored rainfall data, wherein the values of the indexes {rainfall intensity, rainfall pattern, cumulative rainfall capacity, and saturability of slope rock-soil body are {5, 1, 140, 0.1}, respectively. Accordingly, the single index measure evaluating matrix is:

$${( {μ}_{ijk} )}_{rainfall 4 \times 4} = [ \begin{matrix}0 & 0.63 & 0.37 & 0 \\ 1 & 0 & 0 & 0 \\ 0 & 0 & 0.17 & 0.83 \\ 0 & 0 & 0 & 1\end{matrix} ]$$

Next, the weight of each evaluation index is determined, and the weights of rainfall intensity, rainfall pattern, cumulative rainfall and saturability are {0.29, 0.19, 0.32, 0.19}, and then the multi-index measure vector is obtained according to the single-index measure matrix: u₁=w₁μ₁ᵢₖ{0.19, 0.18, 0.16, 0.46}, wherein the confidence degree X, =0.5. Since 0.19+0.18+0.16=0.53>=0.5, the corresponding risk level is level III.

At the same time, the values of the evaluation indexes {crack width, slope of power tower, slope of lower retaining wall and slope of tower base downslope} of the power grid tower on a certain day in November are determined as {20, 29.19, 0.32, 0.86}, respectively, so as to calculate and obtain the evaluating matrix:

$${( {μ}_{ijk} )}_{found 4 \times 4} = [ \begin{matrix}1 & 0 & 0 & 0 \\ 1 & 0 & 0 & 0 \\ 0 & 1 & 0 & 0 \\ 1 & 0 & 0 & 0\end{matrix} ]$$

Then, the weight of each evaluation index is determined. The weights of the evaluation indexes of the crack width, the slope of the power tower, the slope of the lower retaining wall, the slopes of the tower base downslope are {0.25, 0.25, 0.25, 0.25}, and then the multi-index measure vector is obtained according to the single-index measure matrix: u₁=w₁μ₁ᵢₖ={0.75, 0.25, 0, 0}.

Since 0.75>λ=0.5, the corresponding risk level is level I. According to the principle that the evaluation is selected to be the higher risk result between the risk level classification result of the rainfall index and the result of the slope-tower evaluation. Therefore, the comprehensive risk level of the power tower instability is determined as level I, which means high danger.

In the present invention, the evaluating matrix is established respectively in combination with the information entropy and the unascertained degree method by setting the comprehensive risk level of the power tower instability and obtaining the indexes of a landslide section such as the rainfall intensity, rainfall pattern, cumulative rainfall capacity, the saturability of slope rock-soil body during a certain period of time and obtaining the indexes of a power tower in the landslide section such as the crack width, the slope of power tower, the slope of lower retaining wall, the slope of tower base downslope at the same period of time, and then the single-index measure and the multi-index comprehensive measure are obtained. After that, the confidence degree recognition mechanism is introduced. Finally, the determination of the comprehensive risk level of the power tower instability is achieved. Compared to the prior art, the present invention fully considers the two major factors of rainfall characteristics and regional topography conditions, so the precision of the early warning of the landslide is essentially improved, thereby providing the guarantee for the judgment and the early warning of the danger of the power tower. Therefore, compared with the prior art, the technical progress of the present invention is significant, and the present invention has prominent substantive characteristics and remarkable progress.

The above-described embodiments are merely one of the preferred embodiments of the present invention, which should not be used to limit the scope of the invention. For those variations or modifications based on the subject design concept and spirit of the present invention without substantial changes, the technical problem to be solved is the same as that of the present invention, and these variations and modifications should fall into the scope of the present invention.

What is claimed is:

1. A three-dimensional multi-point and multi-index early warning method for risk at a power grid tower in a landslide section, comprising:
(1) establishing a three-dimensional numerical model of a landslide slope, and then performing a single-index risk classification on each of six indexes, including a rainfall intensity, a rainfall pattern, a cumulative rainfall capacity, a saturability of slope rock-soil body, a slope of lower retaining wall, a slope of tower base downslope by using a finite difference method to classify each index into four levels from high to low: I, II, III and IV in terms of risk; at the same time, performing the single-index risk classification on a crack width and a slope of tower based on Technique Code for Building Slope Engineering and Technical Code for Design of tower and pole structures of overhead transmission line to classify each of the crack width and the slope of tower into four levels from high to low: I, II, III, IV in terms of risk;
(2) obtaining the value of each of the indexes, including the rainfall intensity a, rainfall pattern b, the cumulative rainfall capacity c, the saturability of slope rock-soil body d, in a landslide section during a certain period of time, wherein the unit of rainfall intensity is mm/h; the rainfall pattern is divided into a gradually increasing type, a continuously stable type, a first-increasing-then-decreasing type, a gradually decreasing type; the value of the gradually increasing type is recorded as 1, the value of the continuously stable type is recorded as 2, the value of the first-increasing-then-decreasing type is recorded as 3, the value of the gradually decreasing type is recorded as 4; the unit of the cumulative rainfall capacity is mm; the saturability of slope rock-soil body is set to be 0-1 according to water content of soil;
(3) obtaining the value of each of the indexes, including the crack width a′, the slope of tower b′, the slope of lower retaining wall c′, the slope of tower base downslope d′, of a power tower in the landslide section during the same period of time; wherein the unit of the crack width is mm, the unit of the slope of tower is ‰, the units of the slope of lower retaining wall and the slope of tower base downslope are °;
(4) obtaining a rainfall single-index measure evaluating matrix according to the value of each index obtained in step (2):
$$( {μ}_{ijk} ) = [ \begin{matrix}{C}_{a 1} & {C}_{a 2} & {C}_{a 3} & {C}_{a 4} \\ {C}_{b 1} & {C}_{b 2} & {C}_{b 3} & {C}_{b 4} \\ {C}_{c 1} & {C}_{c 2} & {C}_{c 3} & {C}_{c 4} \\ {C}_{d 1} & {C}_{d 2} & {C}_{d 3} & {C}_{d 4}\end{matrix} ]$$
wherein, Cₐ₁, Cₐ₂, Cₐ₃, Cₐ₄ are degrees that actually measured data of the rainfall intensity belong to the four levels of I, II, III, IV, respectively, and Cₐ₁+Cₐ₂+Cₐ₃+Cₐ₄=1; C_{b1}, C_{b2}, C_{b3}, C_{b4} are degrees that actually measured data of the rainfall pattern belong to the four levels of I, II, III, IV respectively, and C_{b1}+C_{b2}+C_{b3}+C_{b4}=1; C_{c1}, C_{c2}, C_{c3}, C_{c4} are degrees that actually measured data of the cumulative rainfall capacity belong to the four levels of I, II, III, IV, respectively, and C_{c1}+C_{c2}+C_{c3}+C_{c4}=1; C_{d1}, C_{d2}, C_{d3}, C_{d4} are degrees that actually measured data of the saturation of slope rock-soil body belong to the four levels of I, II, III, IV, respectively, and C_{d1}+C_{d2}+C_{d3}+C_{d4}=1;
(5) obtaining a slope-tower displacement single-index measure evaluating matrix according to the value of each index obtained in step (3):
$${( {μ}_{ijk} )}^{′} = [ \begin{matrix}{C}_{{a }^{′} 1} & {C}_{{a}^{′} 2} & {C}_{{a}^{′} 3} & {C}_{{a}^{′} 4} \\ {C}_{{b}^{′} 1} & {C}_{{b}^{′} 2} & {C}_{{b}^{′} 3} & {C}_{{b}^{′} 4} \\ {C}_{{c}^{′} 1} & {C}_{{c}^{′} 2} & {C}_{{c}^{′} 3} & {C}_{{c}^{′} 4} \\ {C}_{{d}^{′} 1} & {C}_{{d}^{′} 2} & {C}_{{d}^{′} 3} & {C}_{{d}^{′} 4}\end{matrix} ]$$
wherein, C_{a′1}, C_{a′2}, C_{a′3}, C_{a′4} are degrees that actually measured data of the crack width belong to the four levels of I, II, III, IV, respectively, and C_{a′1}+C_{a′2}+C_{a′3}+C_{a′4}=1; C_{b′1}, C_{b′2}, C_{b′3}, C_{b′4} are degrees that actually measured data of the slope of the tower belong to the four levels of I, II, III, IV, respectively, and C_{b′1}+C_{b′2}+C_{b′3}+C_{b′4}=1; C_{c′1}, C_{c′2}, C_{c′3}, C_{c′4} are degrees that actually measured data of the slope of lower retaining wall belong to the four levels of I, II, III, IV, respectively, and C_{c′1}+C_{c′2}+C_{c′3}+C_{c′4}=1; C_{d′1}, C_{d′2}, C_{d′3}, C_{d′4} are degrees that actually measured data of the slope of tower base downslope belong to the four levels of I, II, III, IV, respectively, and C_{d′1}+C_{d′2}+C_{d′3}+C_{d′4}=1;
(6) determining the weights of the indexes, including the rainfall intensity, the rainfall pattern, the cumulative rainfall capacity, and the saturability of slope rock-soil body, as w₁, w₂, w₃, w₄, respectively, by an entropy weight method according to the single-index measure evaluating matrix obtained in steps (4) and (5); at the same time, determining the weights of the indexes, including the crack width, the slope of the power tower, the slope of the lower retaining wall, and the slope and the tower base downslope, as w′₁, w′₂, w′₃, w′₄, respectively;
(7) calculating multi-index comprehensive measures {A, B, C, D}, {A′, B′, C′, D′} of the slope and the power tower, respectively, according to the determined weight of the indexes, based on the following formula:
uⱼ=wⱼμⱼᵢₖ;
(8) introducing a confidence degree λ=0.5, and comparing the confidence degree with the multi-index comprehensive measures {A, B, C, D}, {A′, B′, C′, D′}, respectively, to determine a comprehensive risk level of power tower instability; wherein the method for determining the comprehensive risk level of power tower instability comprises the following steps: using the left-to-right addition and comparison method, if A≥0.5 or A′≥0.5, then determining the comprehensive risk level of the power tower instability as level I; if A+B≥0.5 or A′+B′≥0.5, determining the comprehensive risk level of the power tower instability as level II; if A′+B′+C′≥0.5, determining the comprehensive risk level of the power tower instability as level III; if A+B+C+D≥0.5 or A′+B′+C′+D′≥0.5, then determining the comprehensive risk level of the power tower instability as level IV;
(9) performing the corresponding early warning based on the comprehensive risk level of the power tower instability, and selecting the higher one among an early warning level of the rainfall index and the early warning level of the slope-tower displacement monitoring as a final early warning risk level.

2. The three-dimensional multi-point and multi-index early warning method for risk at a power grid tower in a landslide section according to claim 1, wherein the rainfall intensity and the rainfall pattern are obtained by processing data of the rainfall intensity and the rainfall pattern measured by a rain gauge.

3. The three-dimensional multi-point and multi-index early warning method for risk at a power grid tower in a landslide section according to claim 1, wherein the cumulative rainfall capacity is determined by a formula:
Pₐ₀=KP₁+K²P₂+K³P₃+ . . . +KⁿPₙ
wherein: P (n=1, 2, 3 . . . n) refers to daily rainfall capacity n days before the outbreak of debris flow, n≥30; K is 0.8˜0.9.

4. The three-dimensional multi-point and multi-index early warning method for risk at a power grid tower in a landslide section according to claim 3, wherein the crack width is measured by a crack meter.

5. The three-dimensional multi-point and multi-index early warning method for risk at a power grid tower in a landslide section according to claim 4, wherein the slope of the power tower, the slope of the lower retaining wall, and the slope of tower base are all measured by a clinometer.

6. The three-dimensional multi-point and multi-index early warning method for risk at a power grid tower in a landslide section according to claim 2, wherein the cumulative rainfall capacity is determined by a formula:
Pₐ₀=KP₁+K²P₂+K³P₃+ . . . +KⁿPₙ
wherein: Pₙ(n=1, 2, 3 . . . n) refers to daily rainfall capacity n days before the outbreak of debris flow, n≥30; K is 0.8˜0.9.
